(19) United States
(12) Patent Application Publication
(10) Pub. No.: US 2005/0189915 A1
(43) Pub. Date: Sep. 1, 2005

(54) Battery arrangement

(75) Inventor: Terrance J. O'Neill, Lake Geneva, WI (US)

Correspondence Address: MICHAEL BEST & FRIEDRICH, LLP, 100 E WISCONSIN AVENUE, MILWAUKEE, WI, 53202, US

(73) Assignee: Quartex, Inc., Lake Geneva, WI (US)

(21) Appl. No.: 10/781,441

(22) Filed: Feb. 18, 2004

(51) Int. Cl. H02J 7/00

(52) U.S. Cl. 320/117

(57) ABSTRACT

A battery arrangement for supplying electrical power from batteries to a battery-powered device. The battery arrangement includes a first receptacle and a second receptacle. Each of the first and second receptacles are adapted to receive at least one of the batteries. An electrical circuit connects the first and second receptacles in a parallel electrical arrangement and extends between the first and second receptacles and the battery-powered device to selectively supply electrical power to the battery-powered device from the battery of the first receptacle or the battery of the second receptacle.

### FIELD OF THE INVENTION

The present invention relates to battery-powered electronic devices and particularly to battery receptacles in such devices. More particularly, the present invention relates to receptacles that hold two or more batteries to electrically connect the batteries to an electronic device.

### BACKGROUND OF THE INVENTION

Typically, a power-consuming or battery-powered electronic device, such as a clock, toy, radio, and the like is powered by one or more batteries and includes one or more battery receptacles for receiving the batteries. The batteries are generally inserted into the receptacles to power the power-consuming device until the charge of the batteries is depleted, at which time the batteries are removed from the receptacles and are replaced with other batteries.

### SUMMARY OF THE INVENTION

The present invention provides a battery arrangement for supplying electrical power from batteries to a battery-powered electronic device. The battery arrangement includes a first receptacle, a second receptacle, each of the first and second receptacles being adapted to receive at least one battery, and an electrical circuit connecting the first and second receptacles in a parallel electrical arrangement and extending between the first and second receptacles and the battery-powered electronic device.

The present invention also provides a battery arrangement for supplying electrical power from batteries to a battery-powered electronic device. The battery arrangement includes a first receptacle, a second receptacle, each of the first and second receptacles being adapted to receive batteries, and an electrical circuit electrically connecting the first and second receptacles and the battery-powered electronic device for transmitting electrical power to the battery-powered electronic device. The transmission of electrical power to the battery-powered electronic device is uninteruptable during replacement of a battery of the first receptacle and during replacement of a battery of the second receptacle.

The present invention further provides a battery arrangement for supplying electrical power from batteries to a battery-powered electronic device; The battery arrangement includes a first receptacle, a second receptacle, each of the first and second receptacles being adapted to receive batteries, and an electrical circuit connecting the first and second receptacles and extending between the first and second receptacles and the power consuming device to selectively supply electrical power to the power consuming device from one of a battery of the first receptacle and a battery of the second receptacle.

The present invention also provides a battery arrangement for supplying electrical power from batteries to a battery-powered electronic device. The battery arrangement includes a first receptacle, a second receptacle, a third receptacle, a fourth receptacle, the first, second, third, and fourth receptacles being adapted to receive batteries, and an electrical circuit having a first path connecting the first and second receptacles and a second path electrically connecting the third and fourth receptacles. The first and second paths are in a parallel electrical arrangement and are electrically connected to the battery-powered electronic device.

Independent features and independent advantages of the invention will become apparent to those skilled in the art upon review of the following detailed description, claims, and drawings.

### BRIEF DESCRIPTION OF THE DRAWINGS

FIG. 1 is a partially exploded rear perspective view of a battery-powered device, such as a clock, and a battery arrangement embodying aspects of the present invention.

FIG. 1A is a top view of an electrical circuit of the battery arrangement shown in FIG. 1.

FIG. 2 is a partially exploded rear perspective view of another construction of a battery-powered device and a battery arrangement embodying aspects of the present invention.

FIG. 2A is a top view of an electrical circuit of the battery arrangement shown in FIG. 2.

FIG. 3 is a schematic view of the battery-powered device and the battery arrangement shown in FIG. 2.

Before at least one construction of the invention is explained in detail, it is to be understood that the invention is not limited in its application to the details of the construction and the arrangements of the components set forth in the following description or illustrated in the drawings. The invention is capable of other constructions and of being practiced or being carried out in various ways. In addition, it is understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and variations thereof herein are used broadly and encompass direct and indirect connections and couplings. In addition, the terms “connected” and “coupled” and variations thereof are not restricted to physical or mechanical connections or couplings.

### DETAILED DESCRIPTION

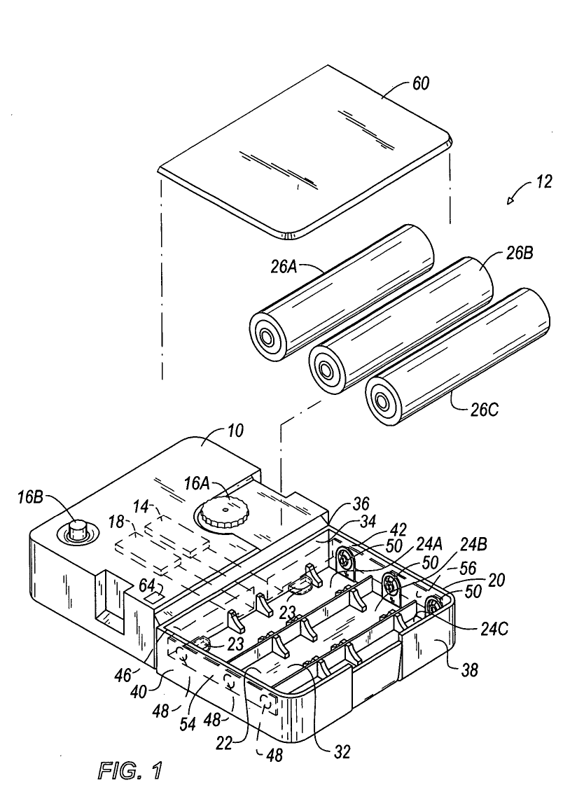

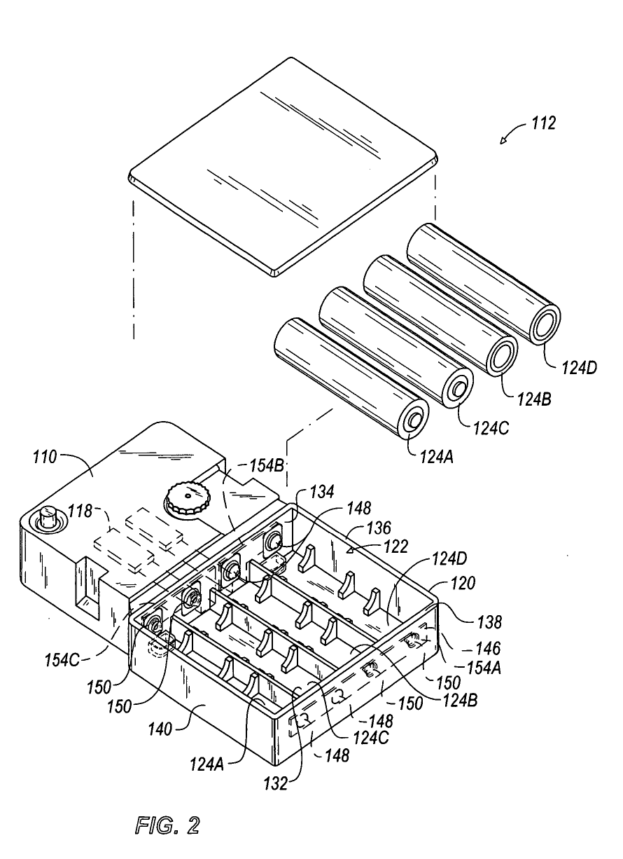

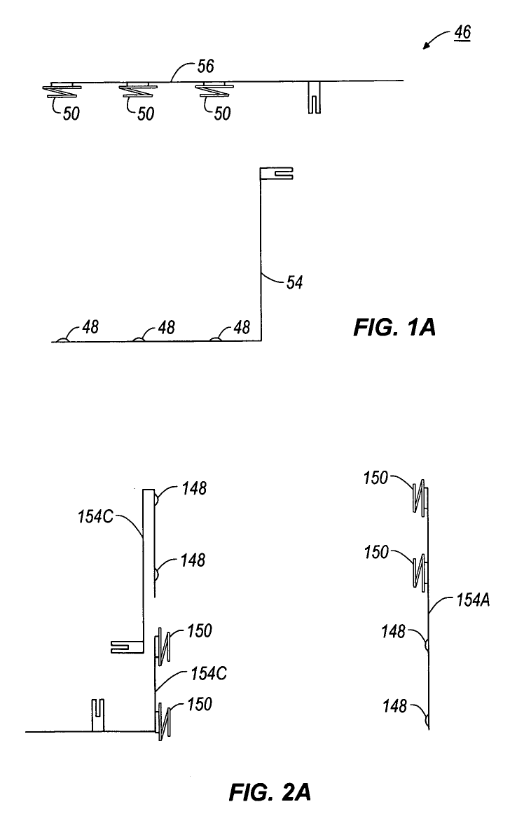

Referring to FIG. 1, a battery-powered electronic device 10 having a battery arrangement 12 according to the present invention is illustrated. In some constructions and in some aspects, the battery-powered device 10 can include a control unit 14, one or more controls 16, and a memory unit 18.

In some aspects and as shown in FIG. 1, the battery-powered device 10 is a clock (e.g., an analog clock, a digital clock, a clock radio, an alarm clock, etc.), the control unit 14 is a clock movement, and the controls 16 are knobs and dials for programming and/or adjusting the clock movement. For example, a first control 16A may be operable to program the time and a second control 16B may be operable to set an alarm (not shown). Also, the memory unit 18 may be operable to store data, including, for example, an alarm time.

In other constructions and in other aspects (not shown), the battery-powered device 10 may be a radio, the control unit 14 may be a radio tuner, the controls 16 may be knobs and dials for adjusting the radio, and the memory unit 18 may be operable to recall preset radio stations or frequencies. In still other constructions and in other aspects (not shown), the battery-powered device 10 may be a toy (e.g., a handheld game or a video game), the control unit 14 may be a toy controller for controlling and organizing game functions, the controls 16 may be knobs and dials for adjusting the toy, and the memory unit 18 may be operable to recall game scores, high scores, and game functions. The battery-powered device may be any device that is powered by an arrangement of batteries, whether the batteries are in receptacles embedded or built into the body of the device or are in a separate battery pack electrically connected to the device, etc.

In the embodiment shown in FIG. 1, the battery arrangement 12 includes a case 20 defining a battery storage space 22. Fasteners 23 connect the case 20 to the battery-powered device 10. In the illustrated construction, the fasteners 23 are outwardly extending tabs formed on the battery powered device 10, which matingly engage corresponding recesses defined in the case 20. In other aspects and in other constructions (not shown), the case 20 can be connected to the battery powered device 10 via screws, bolts, nails, rivets, pins, posts, clips, clamps, and/or other conventional fasteners, inter-engaging elements on the case 20 and the battery powered device 10 (e.g., protrusions, flanges, or other extensions on the case 20 inserted within slots, grooves, or other apertures in the battery powered device 10 wall(s), and vice versa), by adhesive or cohesive bonding material, or in any other suitable manner. Alternatively, the battery storage space 22 may be formed directly into a battery powered device. In this way, there is no need for a case that connects to the battery powered device. For example, the battery storage space 22 may be a cavity in the back of the battery powered device and a cover may be utilized to cover the cavity and contain batteries therein, as is conventional in many battery powered devices.

Battery slots or receptacles 24 extend through the battery storage space 22 and are adapted to receive one or more batteries 26. The particular shape and size of the case 20 is dictated by the size and shape of the batteries 26, the number of batteries 26, and the intended use of the battery powered device 10. In some aspects and as shown in FIG. 1, the case 20 has a generally rectangular configuration and includes a base wall 32 and first, second, third, and fourth sidewalls 34, 36, 38, 40. The top edges of the first, second, third, and fourth sidewalls 34, 36, 38, 40 define an opening 42 to the case 20.

As illustrated in FIG. 1, the battery storage space 22 includes three battery receptacles 24A, 24B, 24C adapted to receive batteries 26A, 26B, 26C, respectively. More particularly, in the illustrated construction, the battery receptacles 24A, 24B, 24C are formed within the case 20 and are each contoured to support cylindrically shaped AA batteries 26A, 26B, 26C. However, in other aspects and in other constructions (not shown), the battery storage space 22 can include two, four, or more battery receptacles 24 and the receptacles 24 can be adapted to receive batteries 26 of any conventional size and configuration, including AAA batteries, C-cell batteries, D-cell batteries, and 9-volt batteries. In still other aspects and in other constructions, the battery storage space 22 can include battery receptacles 24 adapted to receive other batteries 26 of non-conventional shapes and sizes, including, for example, 12-volt batteries, 3.6-volt batteries, 1.2-volt batteries, etc. Each of the battery receptacles 24 may also be adapted to receive a number of batteries 26 (i.e., in an end-to-end or in a side-by-side configuration).

The battery arrangement 12 also includes an electrical circuit 46, a portion of which extends outwardly from the battery storage space 22 and into the battery powered device 10 to electrically connect the battery arrangement 12 and the battery-powered device 10. More particularly, the electrical circuit 46 electrically connects the battery receptacles 24A, 24B, 24C to the battery-powered device 10 to supply electrical power to the battery-powered device 10 from one or more of the batteries 26A, 26B, 26C supported in the battery receptacles 24A, 24B, 24C.

As shown in FIGS. 1 and 1A, the electrical circuit 46 includes positive contacts 48 for electrically engaging the positive terminals of the batteries 26A, 26B, 26C. The electrical circuit 46 also includes negative contacts 50 for electrically engaging the negative terminals of the batteries 26A, 26B, 26C. In some aspects and as shown in FIGS. 1 and 1A, the positive and negative contacts 48, 50 are arranged at opposite ends of the receptacles 24A, 24B, 24C for engaging batteries having positive and negative terminals located at opposite ends. In other aspects and in other constructions (e.g., in constructions in which the batteries 26A, 26B, 26C are 9-volt batteries), the positive and negative contacts 48, 50 are adjacent to one another and are arranged at one end of each of the receptacles 24A, 24B, 24C.

The electrical circuit 46 also includes positive and negative leads 54, 56, which extend through the case 20 and electrically connect the positive and negative contacts 48, 50, respectively. More particularly and as shown in the illustrated construction, positive and negative leads 54, 56 extend along the sidewalls 40, 34 to connect the receptacles 24A, 24B, 24C in three parallel electrical arrangements. In some aspects and as shown in FIGS. 1 and 1A, the positive and negative leads 54, 56 are substantially flat metal ribbons recessed into the sidewalls 40, 34 of the case 20. However, in other aspects and in other constructions (not shown), other conventional electrical transmitting elements, including wires, metallic plates, and the like can also or alternately be used. Similarly, the positive and negative leads 54, 56 can extend along the base wall 32, between the receptacles 24A, 24B, 24C, along the sidewalls 34, 40, over the batteries 26A, 26B, 26C, or through or across any other element of the case 20.

Terminal ends of the positive and negative leads 54, 56 extend into and electrically connect to the battery-powered device 10. In some aspects and as shown in FIG. 1, the positive and negative leads 54, 56 are electrically connected to the controls 16A, 16B and the memory unit 18 and provide electrical power to various elements of the battery-powered device 10.

A cover or lid 60 is engageable with one or more of the sidewalls 34, 36, 38, 40 to substantially enclose the battery storage space 22 and to enclose the batteries 26A, 26B, 26C within the case 20. A fastener (not shown), such as a clip or screw, removeably secures the cover 60 on the case 20 to allow battery replacement.

The battery arrangement 12 also includes an indicator 64 in communication with one or more of the receptacles 24A, 24B, 24C and/or the batteries 26A, 26B, 26C supported in the receptacles 24A, 24B, 24C. The indicator 64 is operable to determine the charge remaining in the batteries 26A, 26B, 26C supported in the receptacles 24A, 24B, 24C. When the indicator 64 records a charge for one of the batteries 26A, 26B, 26C that is below a predetermined value (e.g., 10% of capacity), the indicator 64 notifies the operator that battery replacement is imminent. In this manner, the operator is alerted to the need to replace one or more of the batteries 26A, 26B, 26C before the batteries 26A, 26B, 26C completely lose their charge and the power supply from the battery arrangement 12 to the battery-powered device 10 is interrupted.

As shown in FIG. 1, the indicator 64 includes a light supported on the battery-powered device 10. The light turns on when the charge of one or more of the batteries 26A, 26B, 26C is low to alert an operator that battery replacement is imminent. In other aspects and in other constructions (not shown), the indicator 64 can include an auditory alarm, a flashing light, or any other device to alert an operator of the battery-powered device 10.

The three battery receptacles 24A, 24B, 24C are wired in parallel to each other and then to the battery-powered device 10. In this way, the battery-powered device 10 can draw power from one, two, or three batteries 26A, 26B, 26C supported in the receptacles 24A, 24B, 24C. If only one battery is placed in one of the receptacles 24A, 24B, 24C, the battery-powered device 10 will obviously draw power from only that battery. However, if two or three batteries are placed in the receptacles 24A, 24B, 24C, the battery-powered device will draw power simultaneously from all of the batteries. Because the receptacles 24A, 24B, 24C are arranged in a parallel electrical configuration, the battery-powered device 10 draws a substantially equal amount of power from each of the batteries 26A, 26B, 26C. That is, if there are two batteries placed in the receptacles 24A, 24B, 24C, the battery-powered device 10 will draw a substantially equal amount of power from each of the batteries. If there are three batteries placed in the receptacles 24A, 24B, 24C, the device 10 will draw a substantially equal amount of power from each of the three batteries. In this manner, the useful life of the batteries 26A, 26B, 26C and the time between battery replacements can be significantly increased (i.e., doubled, tripled, etc.) as compared to if only one battery is used.

For example, in aspects in which the battery-powered device 10 requires 1.5 volts (i.e., a single AA battery) for normal operation and only one AA battery is powering the device 10, battery replacement may normally be required every 18 months. However, if the battery-powered device 10 requires 1.5 volts for normal operation and two batteries are placed in the receptacles 24A, 24B, 24C of the battery arrangement 12, battery replacement may only be required every 3 or 4 years. Where the battery-powered device 10 requires 1.5 volts and three batteries are placed in the battery arrangement 12, battery replacement may only be required every 5 years or more.

Also, with at least two batteries in the receptacles 24A, 24B, 24C, each of the batteries 26A, 26B, 26C can be removed from the receptacles 24A, 24B, 24C and can be replaced without interrupting the power supplied by the battery arrangement 12 to the battery-powered device 10 and without interrupting operation of the battery-powered device 10. For example, in constructions in which the battery-powered device 10 is a clock and the battery arrangement 12 includes two or three batteries in the battery receptacles 24A, 24B, 24C, each of the batteries 26A, 26B, 26C can be removed from its respective receptacle and can be replaced without interrupting the power supplied to the clock and without negatively affecting or changing the time displayed by the clock. Similarly, in constructions in which the battery-powered device 10 is an alarm clock and the battery arrangement 12 includes two or three batteries in the three receptacles 24A, 24B, 24C, each of the batteries 26A, 26B, 26C can be removed from its respective receptacle and can be replaced without altering or deleting any information saved in the memory unit 18 (e.g., an alarm time).

To remove or replace a battery 26A, 26B, 26C without interrupting the power supply to the battery-powered device 10, an operator removes the cover 60 from the case 20, exposing the batteries 26A, 26B, 26C. The operator then removes one of the batteries 26A, 26B, 26C (e.g., the first battery 26A) from its receptacle (e.g., the first receptacle 24A) and replaces the battery with a new battery. When the battery is removed from the receptacle, the other batteries (e.g., the second and third batteries 26B, 26C) remain connected to the battery-powered device 10 and continue to supply electrical power to the battery-powered device 10 via the electrical circuit 46. Once the battery (e.g., the first battery 26A) has been replaced, the operator may remove another battery (e.g., the second battery 26B) from its receptacle (e.g., the second receptacle 24B) and replace it with a new battery. When the first two batteries have been replaced, the operator may remove the last battery (e.g., the third battery 26C) from its receptacle (e.g., the third receptacle 24C) and replace it with a new battery.

It should be understood that while the present description refers to removing and replacing one battery 26A, 26B, 26C at a time, in some constructions of the present invention (including the construction shown in FIGS. 1 and 1A), an operator can also or alternately remove two batteries (e.g., the first and second batteries 26A, 26B) at one time while the remaining battery (e.g., the third battery 26C) supplies electrical power to the battery-powered device 10. In still other constructions, the operator can remove and replace one of the batteries (e.g., the first battery 26A) and can leave one of the battery receptacles (e.g., the second receptacle 24B) empty while the battery (e.g., the third battery 26C) of the other receptacle (e.g., the third receptacle 24C) supplies power to the battery-powered device 10. In each case, the parallel electrical configuration of the battery arrangement 10 allows the device 10 to continue to operate regardless of how many receptacles include a battery.

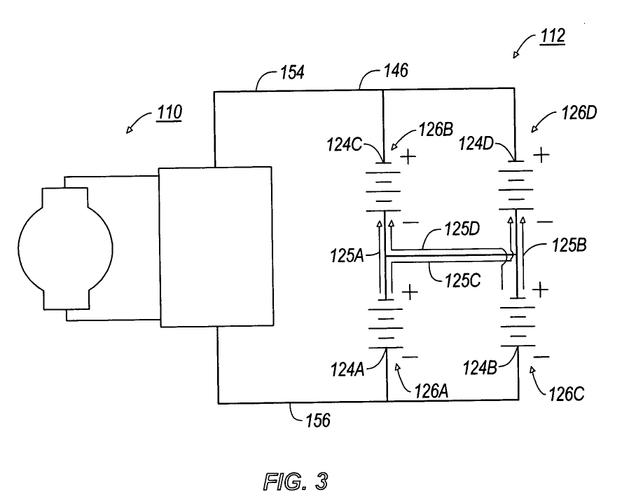

FIGS. 2, 2A, and 3 illustrate an alternate construction of the present invention similar in many ways to the illustrated construction of FIGS. 1 and 1A described above. Accordingly, with the exception of mutually inconsistent features and elements between the construction of FIGS. 2, 2A, and 3 and the construction of FIGS. 1 and 1A, and reference is hereby made to the description above accompanying the construction of FIGS. 1 and 1A for a more complete description of the features and elements (and the alternatives to the features and elements) of the construction of FIGS. 2, 2A, and 3. Features and elements in the construction of FIGS. 2, 2A, and 3 corresponding to features and elements in the construction of FIGS. 1 and 1A are numbered with a corresponding reference numeral in the 100 series.

The battery arrangement 112 of the exemplary construction of FIGS. 2, 2A, and 3 includes a case 120 having a base wall 132 and sidewalls 134, 136, 138, 140, which define a battery storage space 122. The battery storage space 122 includes four battery receptacles 124A, 124B, 124C, 124D for supporting four batteries 126A, 126B, 126C, 126D. In the illustrated construction, the case 120 is connected to the battery-powered device 110 in an orientation in which the longitudinal axes of the batteries 126A, 126B, 126C, 126D supported in the battery receptacles 124A, 124B, 124C, 124D are substantially perpendicular to the bottom or rear wall 138 of the battery-powered device 110. In other aspects and in other constructions (e.g., the construction illustrated in FIG. 1), the case 120 is connected to the battery-powered device 110 in an orientation in which the longitudinal axes of the batteries 126A, 126B, 126C, 126D supported in the battery receptacles 124A, 124B, 124C, 124D are substantially parallel to a bottom or rear wall 138 of the battery-powered device 110.

An electrical circuit 146 (shown in schematic in FIG. 3) extends through the battery case 120 and electrically connects the battery receptacles 124A, 124B, 124C, 124D and the batteries 126A, 126B, 126C, 126D supported in the receptacles 124A, 124B, 124C, 124D to the battery-powered device 110. As shown in FIGS. 2 and 2A, the electrical circuit 146 includes positive and negative contacts 148, 150 located at opposite ends of each of the receptacles 124A, 124B, 124C, 124D. Positive and negative leads 154A, 154B, 154C extend through the case 120 and electrically connect the positive and negative contacts 148, 150 to the battery-powered device 110.

As shown in FIG. 3, the electrical circuit 146 electrically connects the first receptacle 124A and each of the second and fourth receptacles 124B, 124D in series and electrically connects the third receptacle 124C and each of the second and fourth receptacles 124B, 124D in series. More particularly, the electrical circuit electrically connects the first and second receptacles 124A, 124B along a first electrical path 125A and electrically connects the third and fourth receptacles 124C, 124D along a second electrical path 125B. The electrical circuit 146 also electrically connects the pair of the first and second receptacles 124A, 124B and the pair of the third and fourth receptacles 124C, 124D in a parallel electrical arrangement. In this manner, the electrical power supplied to the battery-powered device 110 is approximately equal to twice the output power of one of the batteries 126A, 126B, 126C, 126D. For example, in aspects in which the batteries are AA batteries having approximately 1.5 volts, the battery arrangement 112 continuously supplies approximately 3 volts to the battery-powered device 110.

The battery-powered device 110 can draw power from the pair of batteries 126A, 126B supported in the first and second receptacles 124A, 124B (i.e., along the first electrical path 125A) and the pair of batteries 126C, 126D supported in the third and fourth receptacles 124C, 124D (i.e., along the second electrical path 125B) simultaneously, or alternatively, only one of the two pairs of batteries could be placed in the receptacles, in which case the battery-powered device 110 would draw power from only that pair of batteries 126A, 126B (i.e., along the first electrical path 125A) or 126C, 126D (i.e., along the second electrical path 125B).

More particularly, the battery-powered device 110 can simultaneously draw power from the pair of batteries 126A, 126B (i.e., along the first electrical path 125A) and the pair of batteries 126C, 126D (i.e., along the second electrical path 125B), and because the pair of batteries 126A, 126B supported in the first and second receptacles 124A, 124B and the pair of batteries 126C, 126D supported in the third and fourth receptacles 124C, 124D are arranged in a parallel electrical configuration, the battery-powered device 110 draws an approximately equal amount of power from each pair of batteries 126A, 126B and 126C, 126D. In this manner, the useful life of the batteries 126A, 126B, 126C, 126D and the time between battery replacements can be significantly increased (e.g., doubled).

If any one of the batteries 126A, 126B, 126C, 126D is removed from its respective receptacle 124A, 124B, 124C, 124D, a complete pair in series will still remain and the battery-powered device 110 will continue to run. Also, if two of the four batteries that comprise one of the two pairs 124A, 124B or 124C, 124D, are removed, the remaining pair of two batteries will continue to power the battery-powered device 110.

To remove and replace a battery 126A, 126B, 126C, 126D without interrupting the power supply to the battery-powered device 110 and/or without altering or deleting any information saved in the memory unit 118, an operator removes the cover 160 from the case 120 in a conventional manner, exposing the batteries 126A, 126B, 126C, 126D. The operator then removes one of the batteries 126A, 126B, 126C, 126D (e.g., the first battery 126A) from its receptacle (e.g., the first receptacle 124A) and replaces the battery with a new battery. When either of the first battery 126A or the second battery 126B is removed from its receptacle 124A, 124B, the batteries 126C, 126D of the third and fourth receptacles 124C, 124D remain connected to the battery-powered device 110 and continue to supply electrical power to the battery-powered device 110 via the electrical circuit 146 (i.e., along the second electrical path 125B). Once the battery (e.g., the first battery 126A) has been replaced, the operator may remove another battery (e.g., the second battery 126B) from its receptacle (e.g., the second receptacle 124B) and replace the battery with a new battery. This process is then continued as necessary or until all of the batteries 126A, 126B, 126C, 126D are replaced.

Alternatively, the operator can replace the batteries 126A, 126B of the first and second receptacles 124A, 124B or the operator can replace the batteries 126C, 126D of the third and fourth receptacles 124C, 124D. In still other constructions, the operator can replace the batteries of the first and second receptacles 124A, 124B (or of the third and fourth receptacles 124C, 124D) and can leave the third and fourth receptacles 124C, 124D (or first and second receptacles 124A, 124B) empty.

Lastly, referring to FIG. 3, as discussed, it can be seen that the first and second batteries 126A, 126B are arranged in series with each other and, together, are arranged in parallel with the third and fourth batteries 126C, 126D, which are themselves arranged in series with each other. In addition, a bridge 162 provides an electrical connection between the first pair of batteries 126A, 126B and the second pair of batteries 126C, 126D. The bridge 162 connects the pairs of batteries at a location between each of the individual batteries of each pair. Therefore, in addition to the first battery 126A being serially connected to the second battery 126B and the third battery 126C being serially connected to the fourth battery 126D, the first battery 126A is also serially connected to the fourth battery 126D and the third battery 126C is also serially connected to the second battery 126D. More particularly, the first battery 126A is serially connected to the fourth battery 126D along a third electrical path 125C and the third battery 126C is serially connected to the second battery 126B along a fourth electrical path 125D. In this way, the first and fourth batteries 126A, 126D or the second and third batteries 126B, 126C can be removed and the battery-powered device 110 will continue to operate. Additionally, because of the existence of the bridge 162, if any one of the batteries is removed, two serial paths will actually remain. For example, if the first battery 126A is removed, a serial path will remain through the third battery 126C and the fourth battery 126D (i.e., the second electrical path 125B), but additionally, a serial path will exist through the third battery 126C and the second battery 126B (i.e., the fourth electrical path 125D). In this arrangement, the second battery 126B will drain at approximately twice the rate of either the second battery 126B or the fourth battery 126D, which will drain at approximately the same rate as each other. The battery arrangement 112 effectively provides four pairs of serially connected batteries—a first set 126A, 126B, a second set 126C, 126D, a third set 126A, 126D, and a fourth set 126C, 126B. If any of these sets of two batteries is removed, the remaining set of two batteries will continue to power the battery-powered device 110.

Although the invention has been described in detail with reference to certain preferred constructions, variations and modifications exist within the scope and spirit of one or more aspects of the invention as described and defined in the claims. Also, terms such as “first”, “second”, “third”, and “fourth” are used herein and in the appended claims for purposes of description and are not intended to indicate or imply relative importance or significance.

1. A battery arrangement for supplying electrical power from batteries to a battery-powered electronic device, the battery arrangement comprising:
a first receptacle;
a second receptacle, each of the first and second receptacles being adapted to receive at least one battery; and
an electrical circuit connecting the first and second receptacles in a parallel electrical arrangement and extending between the first and second receptacles and the battery-powered electronic device.

2. The battery arrangement of claim 1, wherein a battery of the first receptacle is removeable during operation of the battery-powered electronic device, and wherein the battery arrangement continuously supplies electrical power to the battery-powered electronic device during removal of a battery of the first receptacle.

3. The battery arrangement of claim 2, wherein a battery of the second receptacle is removeable during operation of the battery-powered electronic device, and wherein a battery of the first receptacle supplies electrical power to the battery-powered electronic device when a battery of the second receptacle is removed and a battery of the second receptacle supplies electrical power to the battery-powered electronic device when a battery of the first receptacle is removed.

4. The battery arrangement of claim 1, wherein each of a battery of the first receptacle and a battery of the second receptacle has a charge, and further comprising an indicator in communication with the first and second battery receptacles, the indicator generating an alert when a charge of a battery of the first receptacle is low or when a charge of a battery of the second receptacle is low.

5. The battery arrangement of claim 1, wherein the first and second receptacles are sized to receive AA batteries.

6. The battery arrangement of claim 1, wherein each of the first and second battery receptacles is adapted to support at least two batteries, and wherein the electrical circuit selectively supplies electrical power to the battery-powered electronic device from batteries of the first receptacle and batteries of the second receptacle.

7. The battery arrangement of claim 1, wherein the battery-powered electronic device includes a clock having a changeable time, and wherein a battery of the first receptacle and a battery of the second receptacle are replaceable without interrupting the time of the clock.

8. The battery arrangement of claim 1, wherein each of a battery of the first receptacle and a battery of the second receptacle has a useful life, and wherein the electrical circuit supplies electrical power to the battery-powered electronic device from batteries of the first and second receptacles for a period of time to increase a useful life of a battery of the first receptacle and a useful life of a battery of the second receptacle.

9. The battery arrangement of claim 1, further comprising a third receptacle adapted to receive at least one battery, the electrical circuit further connecting the third receptacle in a parallel electrical arrangement with the first and second receptacles.

10. A battery arrangement for supplying electrical power from batteries to a battery-powered electronic device, the battery arrangement comprising:
a first receptacle;
a second receptacle, each of the first and second receptacles being adapted to receive batteries; and
an electrical circuit electrically connecting the first and second receptacles and the battery-powered electronic device for transmitting electrical power to the battery-powered electronic device, the transmission of electrical power to the battery-powered electronic device being uninteruptable during replacement of a battery of the first receptacle and during replacement of a battery of the second receptacle.

11. The battery arrangement of claim 10, wherein a battery of the second receptacle supplies electrical power to the battery-powered electronic device during replacement of a battery of the first receptacle and a battery of the first receptacle supplies electrical power to a battery-powered electronic device during replacement of a battery of the second receptacle.

12. The battery arrangement of claim 10, wherein each of a battery of the first receptacle and a battery of the second receptacle has a charge, and further comprising an indicator in communication with the first and second battery receptacles, the indicator generating an alert when a charge a battery of the first receptacle is low or when a charge of a battery of the second receptacle is low.

13. The battery arrangement of claim 10, wherein the first and second receptacles are sized to receive AA batteries.

14. The battery arrangement of claim 10, wherein each of the first and second receptacles is adapted to support at least two batteries, and wherein the electrical circuit selectively supplies electrical power to the battery-powered electronic device from batteries of the first receptacle and batteries of the second receptacle.

15. The battery arrangement of claim 10, wherein the battery-powered electronic device includes a clock having a changeable time, and wherein the changeable time is uninterrupted during replacement of a battery of the first receptacle and during replacement of a battery of the second receptacle.

16. The battery arrangement of claim 10, wherein each of a battery of the first receptacle and a battery of the second receptacle has a useful life, and wherein the electrical circuit supplies electrical power to the battery-powered electronic device from batteries of the first and second receptacles for a period of time to increase a useful life of a battery of the first receptacle and a useful life of a battery of the second receptacle.

17. The battery arrangement of claim 10, further comprising a third receptacle adapted to receive at least one battery, the electrical circuit further connecting the third receptacle in a parallel electrical arrangement with the first and second receptacles.

18. A battery arrangement for supplying electrical power from batteries to a battery-powered electronic device, the battery arrangement comprising:
a first receptacle,
a second receptacle, each of the first and second receptacles being adapted to receive batteries; and
an electrical circuit connecting the first and second receptacles and extending between the first and second receptacles and the power consuming device to selectively supply electrical power to the power consuming device from one of a battery of the first receptacle and a battery of the second receptacle.

19. The battery arrangement of claim 18, wherein the electrical circuit connects the first and second battery receptacles in a parallel electrical arrangement.

20. The battery arrangement of claim 18, wherein a battery of the second receptacle supplies electrical power to the battery-powered electronic device during replacement of a battery of the first receptacle and a battery of the first receptacle supplies electrical power to the battery-powered electronic device during replacement of a battery of the second receptacle.

21. The battery arrangement of claim 18, wherein each of a battery of the first receptacle and a battery of the second receptacle has a charge, and further comprising an indicator in communication with the first and second battery receptacles, the indicator generating an alert when a charge of a battery of the first receptacle is low and when a charge of a battery of the second receptacle is low.

22. The battery arrangement of claim 18, wherein the first and second receptacle are sized to receive AA batteries.

23. A battery arrangement for supplying electrical power from batteries to a battery-powered electronic device, the battery arrangement comprising:
a first receptacle;
a second receptacle;
a third receptacle;
a fourth receptacle, the first, second, third, and fourth receptacles being adapted to receive batteries; and
an electrical circuit having a first path connecting the first and second receptacles and a second path electrically connecting the third and fourth receptacles, the first and second paths being in a parallel electrical arrangement and being electrically connected to the battery-powered electronic device.

24. The battery arrangement of claim 23, wherein when a battery is removed from one of the first receptacle and the second receptacle, the second path electrically connects batteries of the third and fourth receptacles to the battery-powered electronic device.

25. The battery arrangement of claim 23, further comprising a third path electrically connecting the first and fourth receptacles and being electrically connected to the battery-powered device, the third path and at least one of the first and second paths being in a parallel electrical arrangement.

26. The battery arrangement of claim 25, further comprising a fourth path electrically connecting the second and third receptacles and being electrically connected to the battery-powered device, the fourth path and at least one of the first and second paths being in a parallel electrical arrangement.
